(19) United States
(12) Patent Application Publication
(10) Pub. No.: US 2021/0220226 A1
(43) Pub. Date: Jul. 22, 2021

(54) INFANT FEEDING SYSTEMS

(71) Applicant: Mia Nipple System, LLC, Travelers Rest, SC (US)

(72) Inventor: Dru Anne Filter, Greenville, SC (US)

(73) Assignee: Mia Nipple System, LLC, Travelers Rest, SC (US)

(21) Appl. No.: 17/154,009

(22) Filed: Jan. 21, 2021

Related U.S. Application Data
(60) Provisional application No. 62/963,613, filed on Jan. 21, 2020.

(51) Int. Cl. A61J 11/00

(52) U.S. Cl. CPC A61J 11/005

(57) ABSTRACT

Described herein are improved infant feeding systems that mimic the texture and appearance of a mother's breast via improved curvature and asymmetrical contour placement to encourage latch and improved suckling of infants, as well as bottle nipples, pacifiers, medical dispensing tools and kits for same.

### TECHNICAL FIELD

The subject matter disclosed herein is generally directed to improved infant feeding systems including baby bottle nipples, pacifiers, medical dispensing tools and kits for same.

### BACKGROUND

Implements for delivering nutrients to infants have a long and extensive history. Evidence of using wet nurses dates back to the 18th century BCE in Babylon. It was a practice that became the norm among the wealthy classes in Ancient Egypt, Greece and Rome. Soranos of Ephesus, a Greek doctor from the 2nd century BCE, described the ideal wet nurse: “She is between 20 and 40 years of age, honest, even-tempered, pleasant, in good health, has a good complexion, is of average size; her child is less than two months old, she is clean and her milk is neither too clear nor too thick.” A wet nurse was carefully chosen because it was thought that she would pass her qualities, or her vices, onto the child through her milk. Whether its origins were for cultural, moral or medical reasons, this trend was initially restricted to urban areas but was to filter into all levels of society between the 10th and 16th centuries. At the start of the modern era, the whole of Europe went on to adopt this practice: known as nourrices in France, they were called bala in Italy and nodriza or ama in Portugal. There was even talk of a real ‘wet nurse industry’ in the 19th century.

There is also evidence that feeding bottles were used during ancient times. An Egyptian papyrus dating from the 15th century BCE includes a recommendation to use a drink made with “cow's milk and boiled wheat kernels”, undoubtedly in the event that maternal milk was lacking. Soranos provided information on methods for feeding newborns during the Roman era. The colostrum was considered toxic to infants due to its thick consistency and the fact that it was difficult to digest. He advised introducing semi-solid food, such as breadcrumbs soaked in milk, mead, sweet wine or wine sweetened with honey, into the diet from the age of six months, at the onset of teething and to later introduce “gruel, very runny puree and a soft-boiled egg”. Texts written by Avicenna, a Persian doctor and philosopher, provide us with information about the practices in the Middle Ages: he recommended breastfeeding infants for two years and then gradually weaning until the child was able to eat all kinds of food. Infants were often fed animal milk, from cows or goats, as well as clear porridge made from milk and flour, served in horns or receptacles with cloth teats.

To address the lack of wet nurses who were highly sought-after between the 18th and 19th centuries, artificial feeding became extremely popular. Wet nurses often looked after a number of children, raised “on small pots of food, porridge or the family's indigestible soup”. From the mid-19th century, breastfeeding substitutes based on animal milk—donkey, sheep, goat or cow—became increasingly popular in order to combat infant mortality. The discoveries of Pasteur and the subsequent techniques for sterilizing feeding bottles significantly improved the sanitary risks associated with artificial feeding. The use of feeding bottles became widespread. Bottles were initially made from pewter, tin plate, earthenware and porcelain, with glass bottles gradually becoming popular at the start of the 20th century.

A study featured in Nature magazine offers some interesting insights into the feeding devices of antiquity. The levels of barium analyzed in a child's molar from the Neanderthal period suggest that babies were breastfed for seven months, after which feeding was supplemented with other kinds of food for a further seven months, before the child was completely weaned at around 18 months. These results surprised the scientific community, as it is known that, in the natural world, female chimpanzees breastfeed their young for more than five years and that, according to parallel ethnographics, the age of weaning in non-industrialized populations is at around two and a half years of age. However, since this study is based upon the analysis of a single fossil tooth, it is not possible to generalize these findings.

Antique feeding bottles, whether Etruscan, Hellenistic or Roman, retained a certain uniformity in terms of shape spanning thirteen centuries from the 9th century BCE to the 4th century CE. These bottles resembled small beakers with a handle, small enough to be held in the palm of the hand, they were a controversial subject for a long time. They were sometimes considered as feeding bottles but more frequently thought to be recipients used to fill up oil lamps, while glass bottles were thought to be vials for perfume. However, the results of analyses conducted during the 1990s on terracotta and glass feeding bottles confirmed the presence of saturated fatty acids that are only found in human or animal milk (stearic, capric, lauric and miristic acids), proving that these objects did in fact once contain milk. An experiment conducted by a young mother also demonstrated that, due to the shape and the presence of an opening on the top of the ceramic recipients, they may also have been used as a form of breast pump.

One example of prior art devices includes terracotta bottles fitted with a pouring spout and a handle on the side are similar to miniature versions of cooking recipients, jugs or goblets. See FIG. 1. Askoï receptacles feature an off-center opening and a handle on the top, while filter feeding bottles have a lid pierced with small holes. Small in size and with a low holding capacity, they can be held in the palm of the hand and hold one to two deciliters of liquid. Glass gutti bottles emerged during the first century CE and feature a very fine spout that was used to pour out the milk drop by drop.

The modern era ushered in the appearance of the feeding bottle. A turning point came in the 16th century CE, when feeding bottles actually began to be shaped like a bottle, thus replacing the cow horns and terracotta jugs and goblets that had been used since ancient times. The high mortality rate of abandoned children or children left in hospices or with wet nurses, combined with the obsessive fear of depopulation, encouraged doctors to develop artificial feeding techniques based on animal milk. Made from a wide variety of materials, feeding bottles had certain common characteristics: whether made from wood, pewter or glass, the receptacles were tall, looked like bottles and featured a low-flow pierced tip, shaped like a nipple. A piece of fabric or a small sponge was often placed on the tip to prevent the child from hurting its gums during feeding. Solid bottles made from pewter, despite the high rate of mortality that they caused, were commonly used until the 19th century CE.

From the 18th century CE, manufacturers tried to improve the comfort of newborns during feeding by making it easier to clean the receptacles. The ‘flat-shaped’ feeding bottle was then developed, followed by the Anglo-Saxon ‘banana’ made from blown glass. Its elongated shape allowed the baby to remain in an inclined position while its mother controlled the flow of the milk by pressing her thumb over one of the holes. The “clog” bottle featured a raised neck. Some feeding bottles were adorned with magnificent engraved floral designs, evidence of the luxury and wealth of rich European families.

Between 1850 and 1950, the feeding bottle gave into the demands of modern society, which called for products that were tough, practical and inexpensive. Invented in 1860, the long-tube feeding bottle responded to this demand: a glass flask equipped with a rubber tube allowed the infant to more or less feed itself. Although initially acclaimed for its practical nature, this ‘killer tube’ was banned in 1910 as it proved a real breeding ground for bacteria. With the arrival of molded glass, in particular heat-resistant Pyrex® in 1924, came straight feeding bottles, which were graduated and fitted with rubber teats. The neck of the bottle gradually became wider making sure it could be perfectly cleaned. In parallel, the development of new medical disciplines such as pediatrics and childcare contributed towards the diversification of food for newborns and young children. It was in this context that infant cereal and the first powdered milk were invented and developed in Switzerland by Henri Nestle and Maurice Guigoz.

After the Second World War, new materials such as Bakelite appeared. The French manufacturer Remond used this Belgian disclosure from 1946 to create rings, with a view to fitting the teat on the neck of the bottle without actually touching the teat. From the 1960s, the ring, the body of the feeding bottle and the teat protector began to be manufactured out of polypropylene. The designs were now more fun, thanks to images of popular cartoon characters or brand logos that were printed on the bottles using silkscreen printing.

The 21st century, bottle-feeding resembles breastfeeding more than ever. From the 1990s onwards, feeding bottles have given both mother and baby an experience similar to that of maternal breastfeeding. Plastic and silicone feeding bottles are now virtually unbreakable, yet very smooth to touch. Designed for comfort and to minimize fatigue, some are shaped like an S or have play handles to help develop a baby's psychomotricity. Teats have been adapted to babies' needs: they are now made of silicone and available with different flow rates and even “imitate the texture of skin”. Progress has also been made on the health front, with the disclosure of the hygienic removable base and baby bottles made without bisphenol A (BPA), a synthetic compound presumed to be toxic. The summit of this evolution has to be the machine which now prepares baby feeding bottles using milk capsules, in response to the needs of our modern society.

Milk flow, or the rate of milk transfer from the bottle to the mouth during feeding, differs from baby to baby, even at the same ages. A newborn can have a stronger or weaker suck and good or poor coordination of that suck with breathing and swallowing. This can make finding the right flow rate confusing and frustrating.

While infant feeding devices have a long history and significant developments have been made, room for significant improvement remains as issues such as inconsistent hole placement/size/diameter/flow rate and cheap materials cause vagaries and problems while feeding, which can be extremely deleterious in the case of an infant with health issues or in an at-risk situation. Moreover, as each infant's feeding style and physiology is unique, problems such as feeding difficulties, illnesses, malnutrition, poor weight gain, and readmissions to the hospital due to poor fitting of equipment to baby persist creating expense to both parents and insurance companies Accordingly, it is an object of the present disclosure to provide precise, small amounts of liquid nutrient to a child who is learning to feed, especially children in high-health-risk situations. The current disclosure reduces the risk of aspiration of material into the child's lungs and may also be used as a medicine dispenser. Citation or identification of any document in this application is not an admission that such a document is available as prior art to the present disclosure.

### SUMMARY

The above objectives are accomplished according to the present disclosure by providing a baby nipple formed to more perfectly mimic the human female breast. The nipple may include a nipple protrusion, an oblique dome, with the nipple protrusion flairing at a joining region with the oblique dome, at least one irregularly placed protrusion raised from an outer surface of the oblique dome, the oblique dome flairs outward then converges inward to join a substantially columnar nipple lid engagement ring, and wherein the nipple lid engagement ring joins a flat retaining ring. Further, the nipple protrusion may contain at least one inner support member. Yet still, the inner support member may be a concentric ring formed on an inner surface of the nipple protrusion. Again yet, the nipple may have a substantially columnar body that slopes inward as the columnar body forms a rounded top hemisphere of the nipple. Moreover, the nipple protrusion may lack a bulbous tip but instead form the rounded to hemisphere of the nipple. Still yet, the at least one irregularly placed protrusion may be substantially round. Still further, multiple irregularly placed protrusions may be present on the oblique dome. Yet again, the multiple irregularly placed protrusions may be varying shapes and sizes.

In a further embodiment, the present disclosure may provide a method for forming a more perfect mimic for the human female breast. The method may include forming a nipple protrusion, forming an oblique dome, forming the nipple protrusion to flair at a joining point with the oblique dome, forming at least one protrusion on an outer surface of the oblique dome, flaring the oblique dome outward then converging it inward to join a substantially columnar nipple lid engagement ring; and forming the nipple lid engagement ring to join a flat retaining ring. Further, the method may include forming at least one inner support member inside the nipple protrusion. Still yet, the method may provide that inner support member is a concentric ring formed on an inner surface of the nipple protrusion. Again, the method may include forming a substantially columnar body for the nipple protrusion that slopes inward as the columnar body forms a rounded top hemisphere of the nipple. Still further, the nipple protrusion may lack a bulbous tip but instead forms a rounded to hemisphere of the nipple. Moreover, the method may include shaping the at least one irregularly placed protrusion to be substantially round. Still yet, the method may include forming multiple irregularly placed protrusions on the oblique dome. Furthermore, the method may include forming the multiple irregularly placed protrusions to possess varying shapes and sizes.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a prior art terracotta bottle fitted with a pouring spout and a handle.

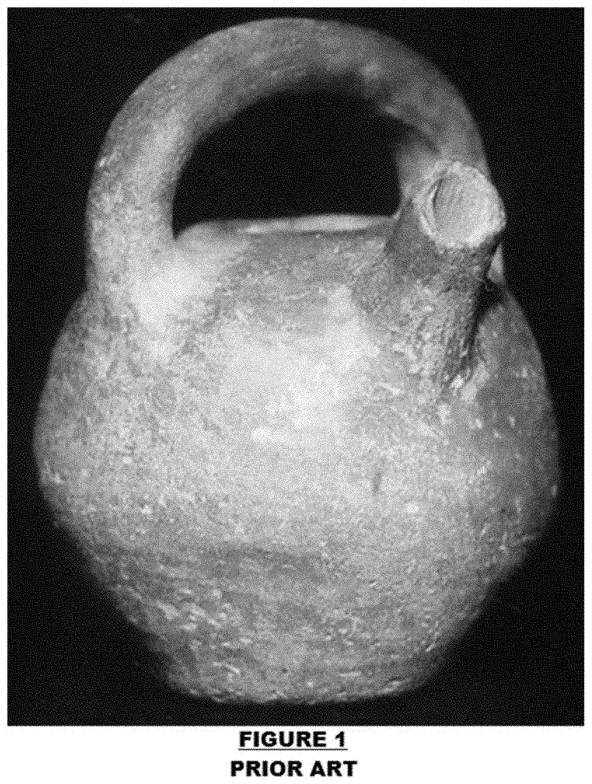

FIG. 2 illustrates one embodiment of a unique nipple design 100 and its shape and texture.

FIG. 2A is a side profile view of FIG. 2.

FIG. 3 shows another embodiment of the disclosure which includes an adjuster ring with multiple orientations.

FIG. 4 illustrates a further embodiment of the disclosure a pacifier design with a similar or same shape and texture as the disclosed nipple design.

FIG. 4A is an alternate design for a pacifier of the current disclosure.

FIG. 5 shows a medicine dispenser embodiment of the current disclosure.

FIG. 5A is an alternate design of a medicine dispenser of the current disclosure.

FIG. 6 is a drawing of a kit of the current disclosure.

FIG. 6A is a photograph of a bottom shelf layer of a kit of the current disclosure.

FIG. 6B is a photograph of a top shelf layer of a kit of the current disclosure.

FIG. 7 shows a dispenser of the current disclosure.

FIG. 8 shows a side-profile view of a female breast.

FIG. 9 shows a common Dr. Brown's NATURAL FLOW® nipple on the market

FIG. 10 shows a front view of a female nipple highlighting the irregular contour of naturally occurring flesh.

FIG. 11 shows one embodiment of mimic nipple of the current disclosure.

FIG. 12 shows an alternate, perspective view of a mimic nipple of the current disclosure.

FIG. 13 shows a downward view looking onto a mimic nipple of the current disclosure.

FIG. 14 shows a pacifier that incorporates aspects of the current disclosure.

FIG. 15 shows an infant feeding system of the current disclosure.

It will be understood by those skilled in the art that one or more aspects of this disclosure can meet certain objectives, while one or more other aspects can meet certain other objectives. Each objective may not apply equally, in all its respects, to every aspect of this disclosure. As such, the preceding objects can be viewed in the alternative with respect to any one aspect of this disclosure. These and other objects and features of the disclosure will become more fully apparent when the following detailed description is read in conjunction with the accompanying figures and examples. However, it is to be understood that both the foregoing summary of the disclosure and the following detailed description are of a preferred embodiment and not restrictive of the disclosure or other alternate embodiments of the disclosure. In particular, while the disclosure is described herein with reference to a number of specific embodiments, it will be appreciated that the description is illustrative of the disclosure and is not constructed as limiting of the disclosure. Various modifications and applications may occur to those who are skilled in the art, without departing from the spirit and the scope of the disclosure, as described by the appended claims Likewise, other objects, features, benefits and advantages of the present disclosure will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

The current disclosure provides, in one embodiment, a system of nipples, pacifier, and Heal-Pro/Medicine Dispenser designed to allow both professionals and parents to better meet babies' unique needs based on their skill set. This system is designed for use among the most fragile of neonates/infants in the NICU setting to normally developing infants from hospital to home and as they continue to develop until approximately one year of age.

The nipples of the current disclosure are not age-based as each baby's sucking pattern differs across the same age and is unique in both pattern and strength. Contrary to infant feeding marketing, for the current disclosure there is no 0-3 month nipple, a 3-6 month nipple, etc., and the nipples of the current disclosure may be used with any infants of any age up to approximately one year old. In one embodiment, a method is provided where information and clinical consultation may be provided for fitting each baby with the appropriate nipple rather than relying on packaging information alone. In another embodiment, a kit may be provided that will contain the various nipples of the current disclosure a box with room for standard bottles below to aid a skilled clinician in evaluating and treating any infant regarding best feeding practices and doctors' recommendations in any setting. There is no such kit currently offered; the Heal-Pro/Medicine Dispenser, as described herein, with the tube and valve application is unique.

The present disclosure relates to the unique shape and texture of an entire set of graduated flow nipples with holes in the form of a circle that deliver milk in precise flow rates as well as one nipple in which the hole is oval in shape allowing for variability of flow with a slight twist of the bottle. Tasty Tip™ OD (0.2 mm), Super Sucker™ OD (0.23 mm), Preemie OD (0.26 mm), Newborn™ OD (0.29 mm), Mature Master™ OD (0.35 mm), Skilled Coordinator™ OD (0.45 mm), Cereal Sipper™ OD (0.60 mm), Cereal Smoothie™ OD (0.80 mm), Smooth Adjuster™ Oval Nipple (0.75 Maj.−0.25 Min.) mm. to (1.0 Maj.−0.75 Min.), The Calm-Me™ (pacifier same as nipple with wide ring and handle) No hole, Heal-Pro™ (Medicine dispenser with center hole (0.60 to 1.0 mm), NG tube and Luer Lock or Enfit lock or Slip Lock), which may all be in a Pro Kit™ (with all 11 products in a carrying box).

In one embodiment, there may be 11 different products including 9 nipples ranging in flow rates, one Calm-Me™ pacifier, and the Heal-Pro Medicine Dispenser as well as a kit which contains all 11 products. The products are designed to provide the precise nipple flow rate for any type of baby's feeding needs. The products are designed to be used with all babies that can safely feed by mouth including medically fragile babies with special feeding requirements as well as normally developing babies. The kit which contains all products is the ultimate tool for skilled feeding therapists. It is intended for use by professionals with specialized training, which we will also provide, to feed babies with special needs and fitting newborn babies without feeding problems. It is well recognized that problems can be created by not fitting a normally developing infant with the proper flow rate initially. Education and web information will also help parents make educated decisions regarding fitting their newborns with appropriate flow rates from the hospital to home and when a baby needs to transition from one nipple to another flow rate based on that baby's skills . . . not an age or size. The unique shape of the nipple will be consistent with both the Calm-Me™ pacifier and the Heal-Pro Medicine Dispenser. The Heal-Pro Medicine Dispenser is a unique disclosure designed to help all babies, including medically fragile infants, transition from tube feedings to oral feedings gradually in the hands of a feeding specialist in a medical setting or in home health environments. It administers controlled safe amounts of fluids (formula, breast milk or liquid medicine) in a non-invasive way than traditionally performed today. It has a tube attached to the center of the nipple with a one-way valve that has a syringe fitting on it. This allows for the baby to suck on the nipple with or without delivery of fluid depending on the baby's needs and cues. It can also be used in the home environment by parents as a medicine dispenser alone. No other medicine dispenser has tubing which allows for administration in multiple positions and angles. This entire system is comprehensive. Any baby who can safely orally feed, or who is beginning to in the hands of a professional, can apply its use in many formats. It is meant to be used throughout the entire bottle feeding career of any baby with any range of need.

A Calm-Me pacifier and a Heal-Pro/Medicine Dispenser may also be part of the system allowing for consistency of sucking patterns from breast to bottle to pacifier with minimum need for physiological changes. The Heal-Pro/Medicine Dispenser allows for a skilled feeding therapist to deliver precise small amounts of liquid to a baby who is learning to feed in a high-risk situation. It may also allow for the delivery of precise amounts of liquid medicines to the baby orally. This system reduces the risk of aspiration of fluids into the lungs. It can also be used as a medicine dispenser in the home setting by caregivers. It is a great transitional “training” tool to transition babies from nasogastric to oral feedings, i.e., from tubing inserted through the nose and into the stomach.

In one embodiment, a Dru Nipple System may be provided. The system relates to the uniquely shaped bottle nipples that are of standard width to fit all standard size bottles such as bottles with a 38 to 49 mm neck, as commonly found on the market. The current disclosure's shape and texture allow for a baby to latch onto the nipple more like an actual breast. The hole sizes graduate in size from extremely slow to a large circle hole meant for use with feeding babies who are prescribed cereal and other thickening agents in their formula for reflux or swallowing purposes. There is also a variable flow oval nipple and ring that allows for smooth transitioning between slow, medium, and fast flow rates while the nipple remains in the mouth.

In a further embodiment, nipples intended for use with cereal infused liquids are either cross-cut or Y-cut allowing for stretching with continued use which increases the flow posing a danger to the infant. Another feature of the system is that there will be literature, conferences, web-based, and LIVE support available with information for best use of the equipment offered. In a further embodiment, a pacifier, such as the Calm-Me Pacifier™, may be provided. The Calm-Me™ Pacifier relates to a uniquely shaped nipple on a broad base. The pacifier is hollow and has a hole in the base designed for attachment of the pacifier by a ribbon (available on the common market) to the baby's clothes.

In a further embodiment, a Calm-Me™ Paci-Trainer/Medicine Dispenser may be provided. This may be a Dru Pacifier™ with a hole near the base of the nipple for a tiny tube to fit in along with a one-way valve allowing for a syringe to be attached to deliver precise amounts of milk or medicine to the baby at the corner of their mouth in a smooth controlled manner.

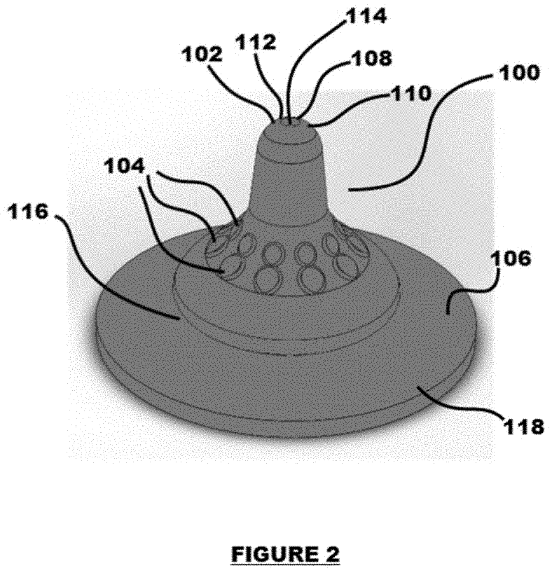

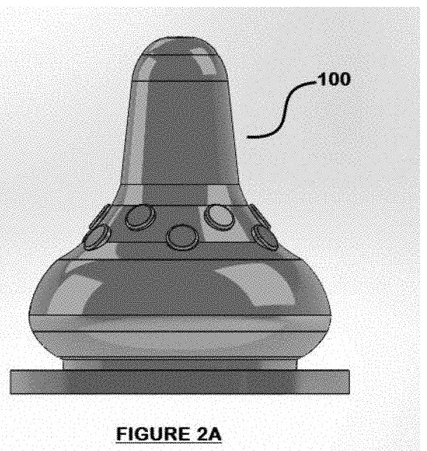

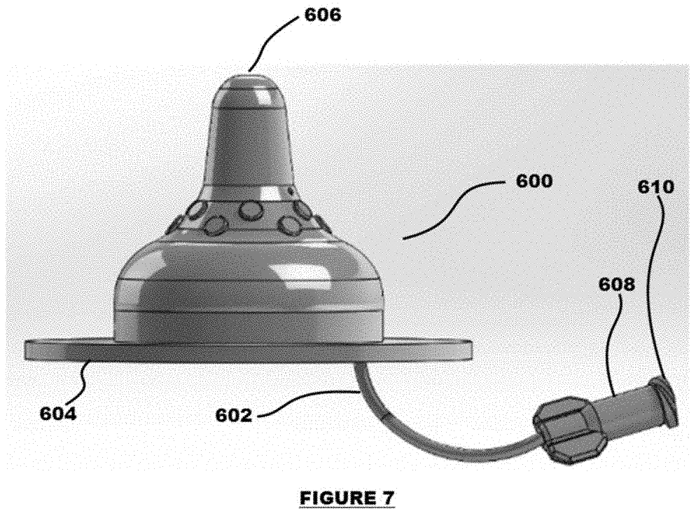

FIG. 2 illustrates one embodiment of a unique nipple design 100 and its shape and texture. Nipple 102 is not as long or wide as standard sized nipples, such as those available from PARANTS (0.68 mm), GERBER (0.78 mm), BROWN (0.7 mm), AVENT (0.68 mm), on the market with the intent of limiting the gag response of infants upon the introduction of the nipple. For instance, the current disclosure may have size ranges from 0.5 to 0.7 mm) Nipple design 100 may be made from The tiny oval shaped raised projections 104 near base 106 of nipple design 100 are to allow for easier latch with the wideness of base 106 encouraging better lip flange for a tighter contact seal. Projections 104 may be varied in size and placement on nipple design 100. The pattern of projections 104 may have projections 104 in line with one another, see FIG. 2, or may have projections 104 placed in a “staggered” or offset pattern, see FIG. 7. Further, file two rows of projections 104 are illustrated, more or less rows are within the scope of this disclosure such as 1, 3, 4, 5, 6 or more rows of projections 104. Projections 104 may be varied in shape and size from one another to more accurately reflect the texture of a mother's breast or uniform. Further, projectiles 104 may be various shapes such as round, oblong, dome shaped, etc. In a preferred embodiment, projections 104 are round. Base 106 may also be formed to be substantially or slightly convex in appearance with central region 116 higher hand peripheral region 118 with respect to nipple tip 110. This in turn promotes less ingestion of gas while the baby is sucking. The opening hole 108 at tip 110 of nipple 102 will vary in circumference 112 and depth 114 to vary the flow rate of each nipple from the slowest available on the market to faster flows which will accommodate each baby's unique needs based on their own skill set and condition(s) such as variability of suck strength and coordination within a feed. The number of projections 104 and their placement on nipple 102 may be random or arranged in a pattern. In one embodiment, to more accurately reflect the feel of a mother's breast, projections 104 may be located from 10-18 mm from tip 110 of nipple 102. It is important that all flow rates be available under the same shaped nipple. Once a baby becomes accustomed to a nipple's shape and texture, he/she is very unlikely to accept one of a differing shape or texture. This can lead to rejection or problematic feedings when a different flow rate is needed that is not offered in the brand that the baby is already accustomed to as skills and needs change over time. FIG. 2A is a side profile view of FIG. 2.

The unique shape and texture of the current disclosure is like no other brand, simulating a human breast with multiple characteristics. The holes are all round with the exception of the variable flow nipple which creates a smoother and more consistent flow rate in multiple circumstances, including with the addition of cereal to the milk. Nipples of the current disclosure fit every standard shaped bottle, including the hospital variety. The pacifier and paci-trainer (another unique product) are formed in the same shape. The paci-trainer allows for an external control of the flow rate, which is an application that is safer and useful in a variety of circumstances. The current disclosure may include both written information and web-based support to help best fit each unique baby with the proper flow rate, technique of feeding, and education regarding what a “good” and “bad” feeding looks like. Further, actual, live therapist skilled support will lead to safer and more efficient feedings, less readmissions or need for medical assistance or getting to a specialist earlier for preventative care. The kit will be a tool all skilled therapists will appreciate tremendously.

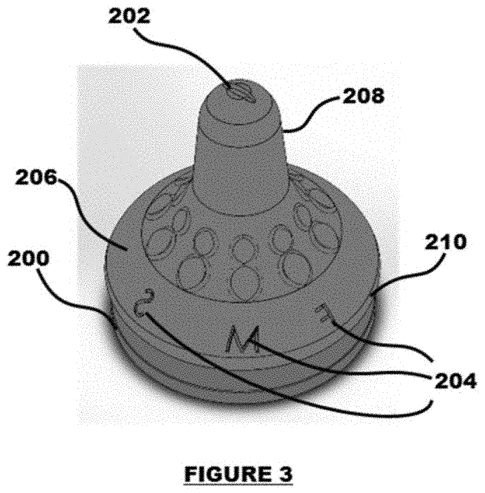

FIG. 3 shows another embodiment of the disclosure which includes an adjuster ring 200. This embodiment includes a variable flow rate nipple 202 and setting indicator markings 204. In one embodiment, variable rate nipple 202 may be oval in shape. Setting indicators markings 204 may comprise slow, medium and fast settings. While these markings are shown on upper surface 206 of nipple 208, they may also be placed on peripheral edge 210 so that one looking down on the bottle, not shown, may see indicator markings 204, such a caregiver holding an infant in his lap. Adjustment of flow may be made by slightly twisting adjuster ring 200, such as via a 15 degree twist to increase or decrease flow by exposing more or less of the flow opening.

The current disclosure provides a device that has an extremely limited and precise flow of liquid to the infant to reduce the risk of aspiration of fluid to the lungs or escape out the corners of the mouth when training high risk non-oral feeders to bottle feed when they are more medically stable. Medicine dispensers currently on the market offer only one flow rate which is usually considered too fast for many babies to handle and pose risks of either loss of medicine out of the corners of the mouth (so improper dosing) or aspiration of fluid into the lungs when the baby cannot handle the faster flow. Current products do not offer the flexible tubing so that current market devices may be used in any orientation/position.

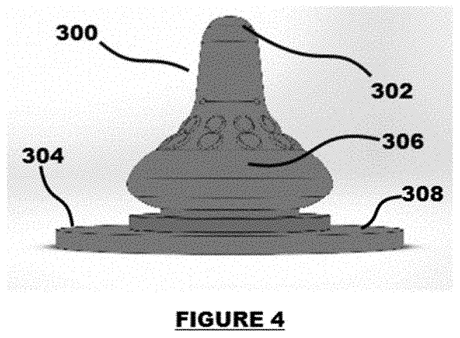

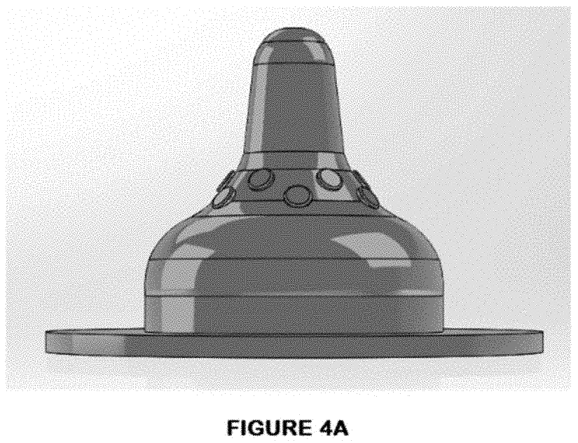

FIG. 4 illustrates a further embodiment of the disclosure, pacifier design 300 with the same shape and texture as nipple design 100. Pacifier design 200 may not define a hole in nipple 302 and nipple 302 and base 304 may be thicker than the embodiment shown in FIG. 2. Pacifier design 300 may also have a hollow core 306. Pacifier design 300 may also define an opening 308, which may be of various shapes such as circle, oblong, parallelogram, rhomboid, etc. The opening may be used to accommodate a ribbon, not shown, or other method of tying pacifier design 300 to a child's clothing or other location. Pacifier projections 303 may be arranged in columns or staggered from one another and may be of varied heights and dimensions. Further, the number of rows of pacifier projections 303 may be more or less than two, such as one, three, four, five, etc., and the current disclosure should not be limited to two rows of pacifier projections.

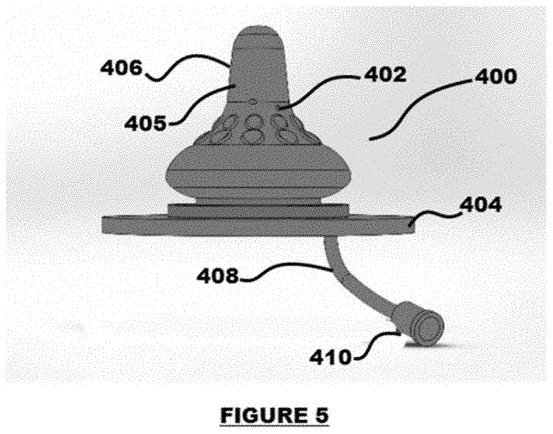

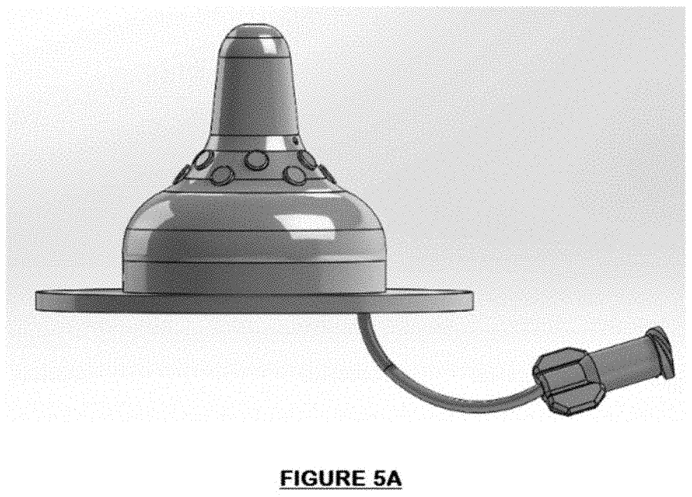

FIG. 5 shows a further embodiment of the current disclosure that provides a medicine dispenser 400. Medicine dispenser, in one instance may comprise a “Paci-Trainer/Medicine Dispenser” with similar or identical shape, texture and size characteristics to pacifier design 300. A small hole 402 will be at base 404 of nipple 406 and fed to midline with tube 408, which may comprise food grade silicone, connecting to it right at the corner of the baby's lips, not shown. Tube 408 may range in length from 5-10 cm. While only one hole 402 is shown, more holes may be employed, such as 2, 3, 4, 5, 6, etc., with varying sized holes located along and around nipple stem 405 of nipple 406. Tube 408 may employ a one-way valve 410 and allow for liquids such as breast milk, thickened liquids, milk with cereal, formula or medicine to be pushed in a slow controlled manner into the baby's mouth while they are sucking on the pacifier non-nutritively. Dispenser 400 is designed to safely teach a baby that sucking and flavor are associated with minimal risk of aspiration. A syringe, not shown, may be attached and can be a 0 cc, 1 cc, 3 cc, or 5 cc volume. Dispenser 400 is not intended for use as a feeding system, but a tool for skilled feeding therapists to use to have baby transition from nasogastric or PEG tube feedings to oral feedings in a medical/clinical setting. Dispenser 400 may also be used to administer doses of liquid medicines in a slow controlled manner in the clinical or hospital setting as well as at home. One way valve 410, via tube 408, may engage a male or female luer lock syringe which may be removed once the medicine is dispensed. Further, one way valve 410, via tube 408, may engage a luer lock syringe or feeding delivery set if needed.

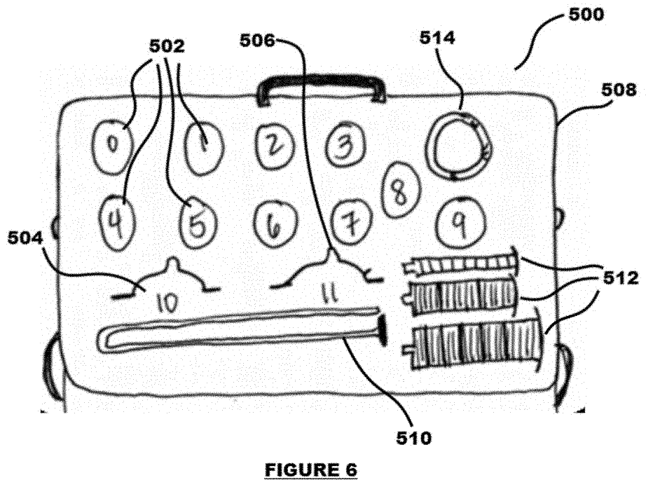

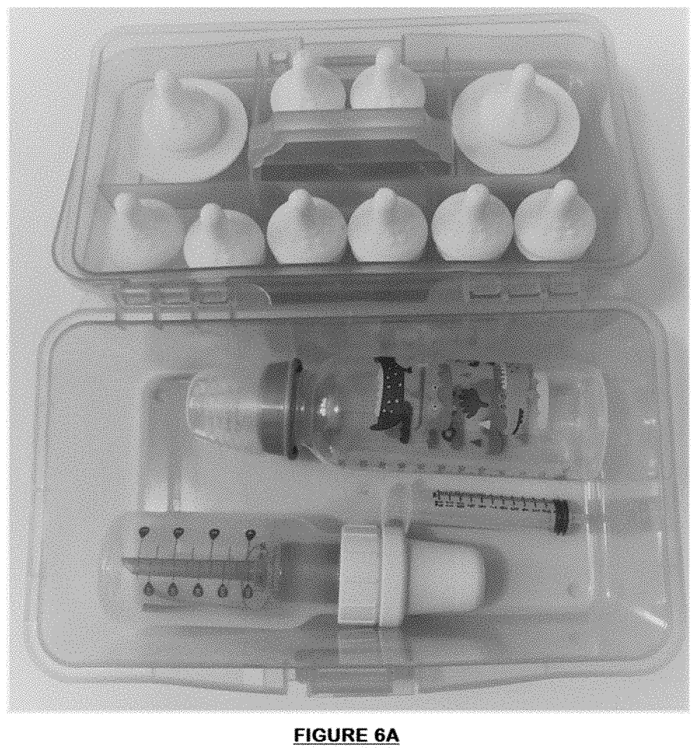

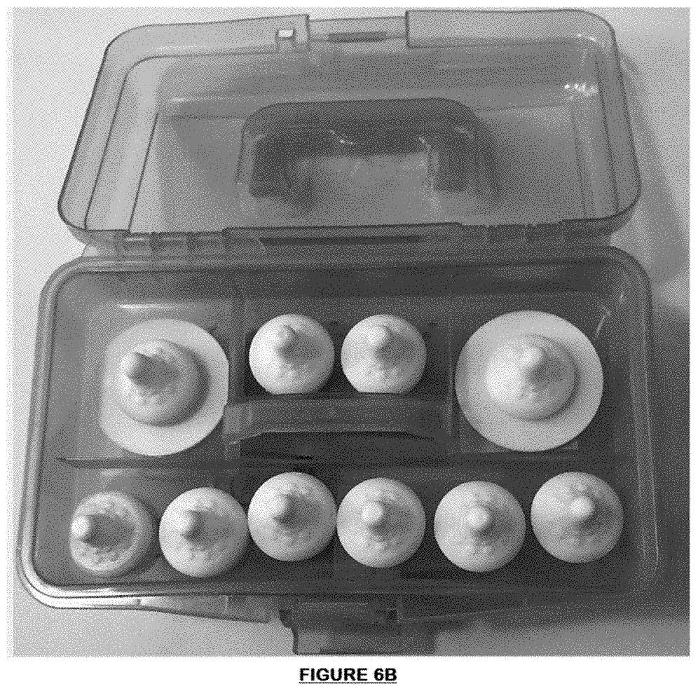

FIG. 6 is a drawing of a kit 500 of the current disclosure. Kit 500 may have all components for a professional feeding therapist to evaluate, fit a baby with the appropriate nipple, or treat with appropriate nipple or paci-trainer/medicine dispenser. Typically a health care provider would have to carry around cumbersome bags/boxes of various bottles/nipples from many brands in order to custom fit a baby with an appropriate size, shape, flow rate, etc. This without having all the tools necessary for some babies for a perfect feed as provided via the current disclosure. Kit 500 has every flow rate necessary to feed any baby at any time of development or transition based on their own unique skill set and sometimes even medical needs/conditions.

In one example, kit 500 may contain: nipples 502 of differing flow rates; 1 pacifier 504 with an identical shape to nipples 502; 1 PaciTrainer 506 for safe administration of liquid medications and training for medically fragile babies transitioning from tube feedings to feedings by bottle and/or breast; 1 box 508 with designated and labeled holes to put each nipple and pacifier in for ease of identifying equipment rapidly with storage space below for bottles and other equipment for feeding therapy. Kit 500 may also include a tube 510 for connection to Heal-Pro 506 as well as graduated syringes 512 for introduce fluids to Heal-Pro 506 and an adjuster ring 514 to help control fluid flow through nipples 502.

FIG. 7 shows another embodiment of the disclosure, a Heal-Pro trainer dispenser 600. Heal-Pro trainer dispenser 600 may have French tube 602 either integrally affixed or separably affixed to dispenser body 604. French tube 602 will allows medicine, milk, formula, etc., to exit from nipple center front 606 of dispenser 600. Dispenser 600 may also have a one-way valve 608, which ensures fluids may go into but not out of dispenser 600. These valves may be LEUR, ENFIT, SLIP-FIT or other commercially available valves. One-way valve 608 may also have a syringe engagement end 610, which would allow a user to inject fluids, medications, etc., into one-way valve 608. Typical syringes ranging from 0 cc to 20 cc may be accommodated by syringe engagement end 610. Heal-Pro trainer dispenser 600 may be made from food grade silicon, among other materials. Further, Heal-Pro dispenser 600 may accommodate syringes ranging in size from 0 to 20 cc.

Among other factors, two features that differentiate a nipple of the current disclosure from other brands are the inventors' goal to mimic the human nipple by designing the nipple to be shaped, as well as look and feel, like a human nipple to feeding infant. Two aspects of this are the profile of the nipple and the “bumps” or projections placed/formed in an irregular pattern on the upper surface of the nipple, which contacts the infant's lips. The criticality of the nipple's structure cannot be understated as “the users”, infants, lack full cognitive ability as it is in a nascent state and function predominately on instinct. Ergo, a feeding device that does not trigger the instinctual comfort of a mother's nipple is more likely to be rejected by the infant, thereby reducing or inhibiting feeding entirely, which may be extremely dangerous for any baby, from normally developing to premature or low weight infants.

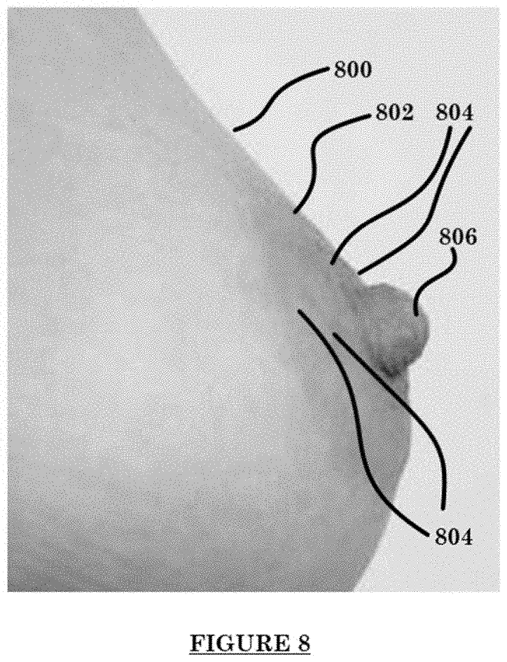

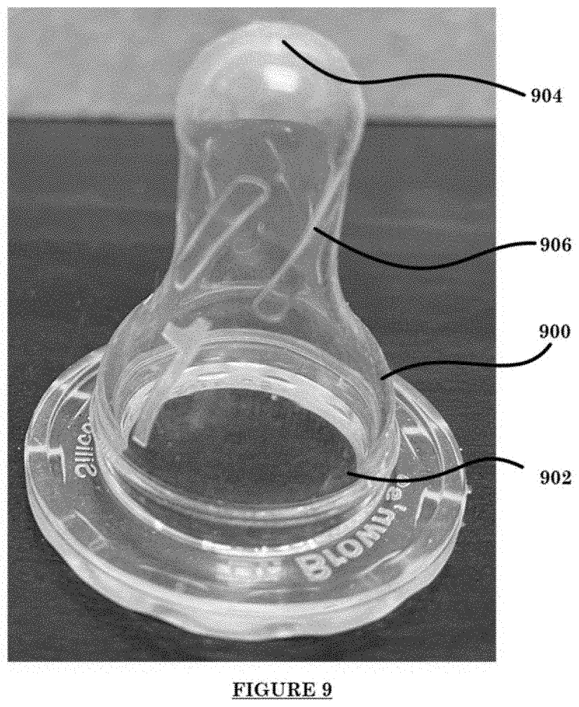

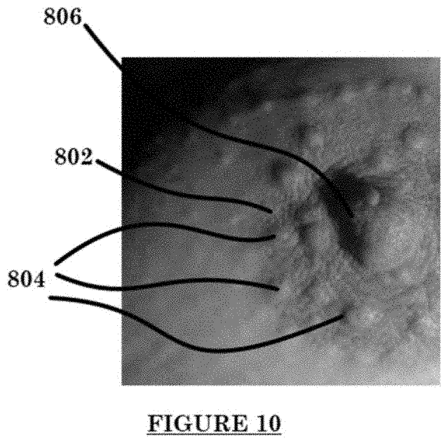

FIG. 8 shows a side-profile view of a female breast 800 illustrating the areola 802 and Montgomery tubercles (the “bumps” on a nipple) 804 surrounding nipple 806. As the photo shows, a human breast has irregular Montgomery tubercle placement. By irregular, this application defines the term as not conforming to a pattern and lacking distinct symmetry and evenness of placement on the infant-facing surface of nipples of the current disclosure. Thus, the projections placed on the nipples of the current disclosure will not be placed in a regular formation. Indeed, as shown and discussed herein, projection placement will be placed randomly without pattern using projections of different sizes and shapes on the infant-facing surface of the nipple. The projections are raised from the surface of the infant facing surface and are substantially round or oval in shape. The projections can be ovals, circles, oblongs, etc., wherein different sized and shaped projections appear on the same nipple surface in order to match the irregularity nature produces in a mother's breast. FIG. 9 shows a common Dr. Brown's NATURAL FLOW® nipple on the market; the shape of the existing nipple has little or no resemblance to the real nipple shown in FIG. 8. As FIG. 9 shows, this nipple has a smooth outer surface 900 covering the nipple from the base 902 to nipple top 904. While nipple ridges 906 are shown in FIG. 9, these are located on the interior surface of the nipple, not the infant-facing surface. FIG. 10 shows a front view of a female nipple highlighting the irregular contour of a naturally occurring flesh, which the current disclosure seeks to mimic.

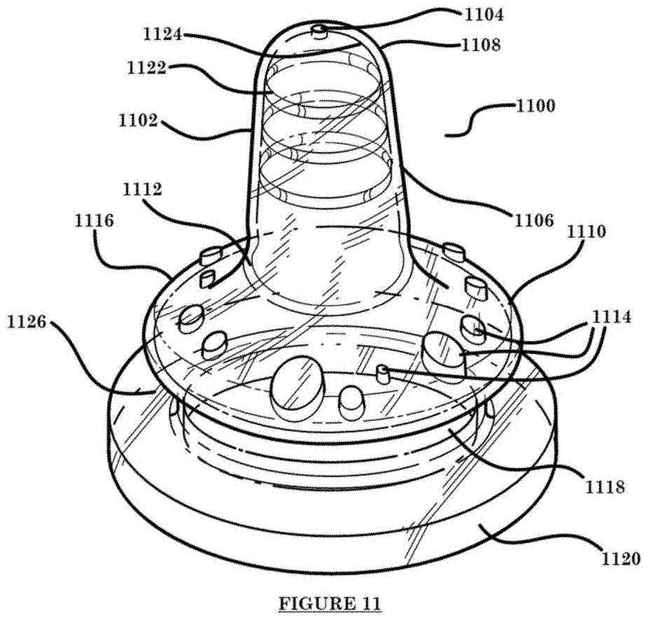

FIG. 11 shows one embodiment of mimic nipple 1100 of the current disclosure. Mimic nipple 1100 is shaped to more perfectly mimic the human female breast. Mimic nipple 1100 may be made from latex or silicone and formed via a molding process as known to those of skill in the art. Mimic nipple 1100 may also be transparent in order to see within mimic nipple 1100. Mimic nipple 1100 includes nipple protrusion 1102. Nipple protrusion 1102 is generally smooth in shape, but may also contain irregularly placed protrusions 1114 as described infra. Nipple protrusion 1102 defines opening 1104 and is substantially a rounded column forming rounded columnar body 1106 ending in a rounded top hemisphere 1108 that defines opening 1104. Nipple protrusion 1102 lacks a bulbous or flared end as common with some nipples, see FIG. 9, as a more “orthodontic” or bulbous shaped tip encourages a baby to use only compression or a munching pattern to express milk from the nipple. The rounded columnar body encourages both compression and stripping by the tongue, which simulates the way a baby sucks on a human breast. Nipple 1100 may include oblique dome 1110. Nipple protrusion 1102 may flair outward at a joining section 1112 with oblique dome 1110. Oblique dome 1110 may define at least one irregularly placed protrusion 1114 raised from outer surface 1116 of oblique dome 1110. Oblique dome 1110 may curve outward and downward then converge inward, giving oblique dome 1110 a slightly “flattened onion” appearance to better mimic the curvature associated with a human nipple and breast's areola as well as to firmly secure the nipple in a baby bottle cap, Indeed, when comparing a nipple of the present disclosure to the one show in FIG. 9, the current disclosure nipple appears more flesh-like in appearance, as well as provides a widened base for an infant to latch upon and suckle. Oblique dome 1110 joins a substantially columnar nipple lid engagement ring 1118 to form cleft 1126 , which engages the inner surface of a baby bottle lid, not shown. Nipple lid engagement ring may then flair or flange outward to form a flat retaining ring 1120, which engages the underside of the baby bottle cap, to hold mimic nipple 1100 in place within a baby bottle cap. Mimic nipple 1110 may also include at least one inner support member 1122 that helps nipple protrusion 1102 maintain its shape compress or flatten and, thus, allow flow of milk or other fluids to the infant feeding. While three (3) inner support members 1122 are shown, more or less are envisioned within the scope of this disclosure such as 1, 2, 4, 5, 6 or more and the disclosure should not be considered limited to the number shown in FIG. 11. Inner support member may be shaped as a concentric ring formed on inner surface 1124 of nipple protrusion 1102. (previously explained above) Nipple protrusion 1102 may be shaped to be substantially columnar and slope inward as rounded columnar body 1106 forms rounded top hemisphere 1108.

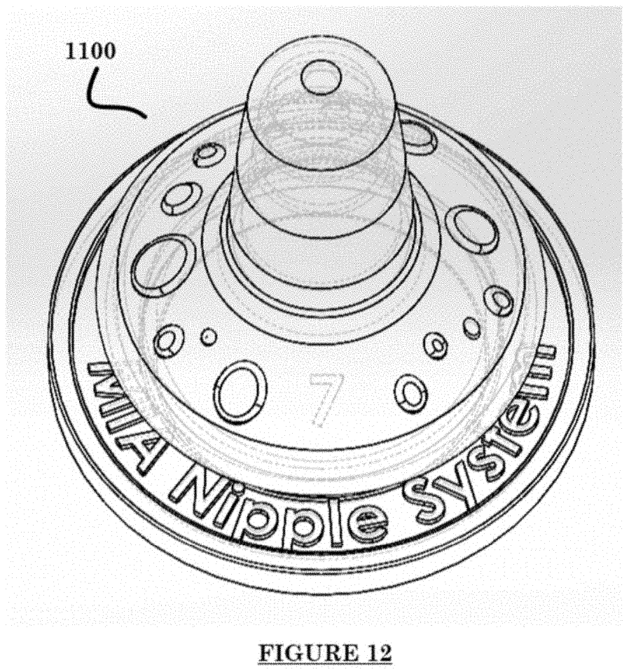

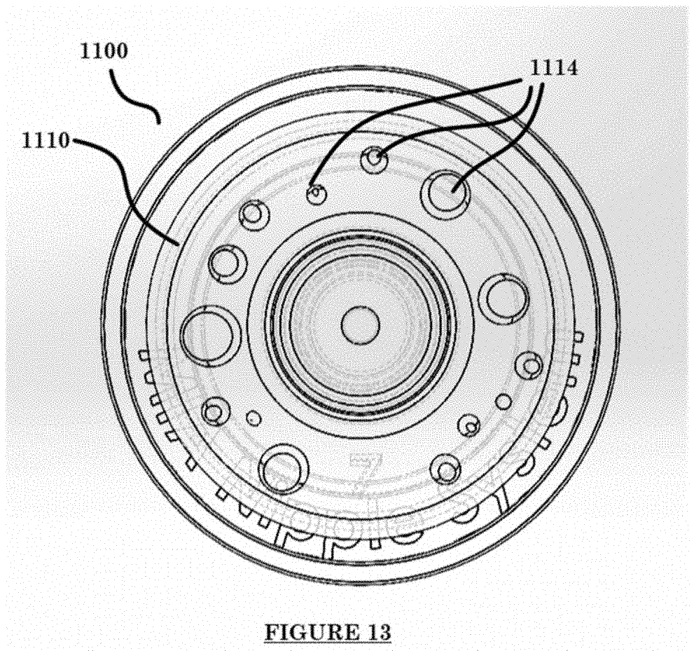

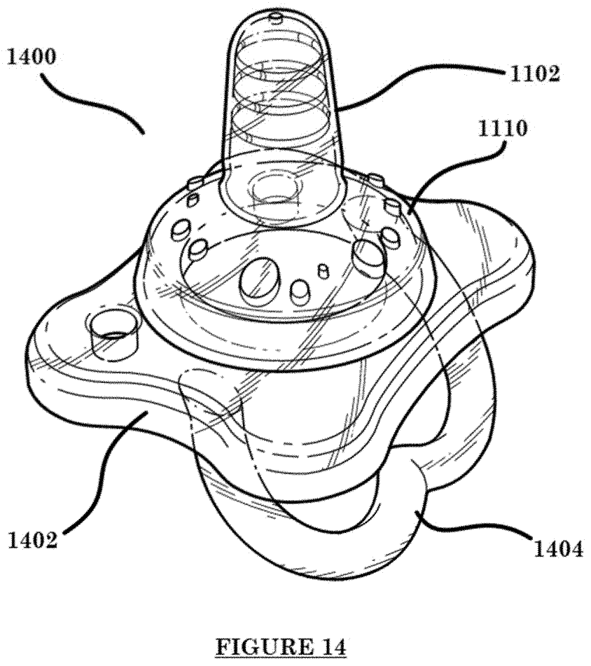

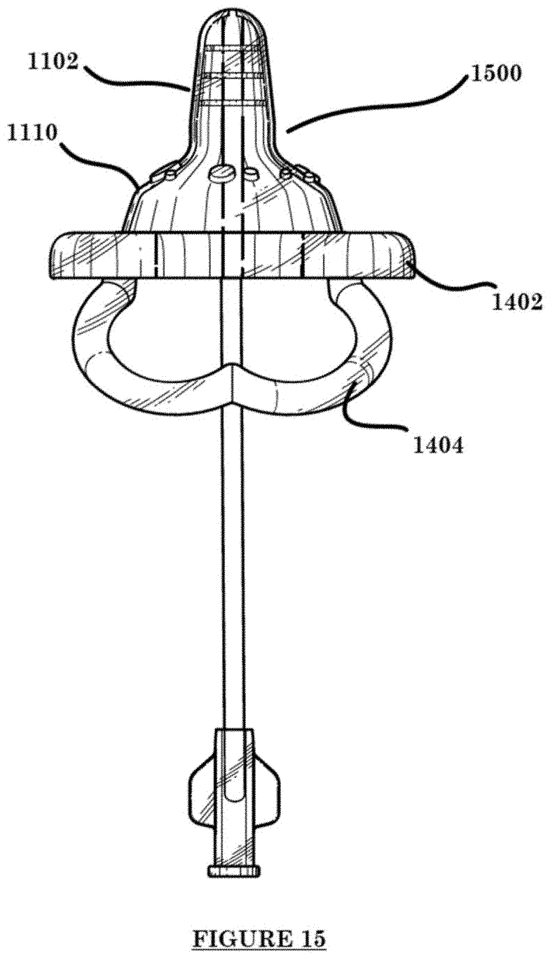

The shapes of irregularly placed protrusion 1114 is substantially round and/or oval. Protrusion 1114 will be raised from the surface of the nipple in three dimensions: length, width and depth. Multiple irregularly placed protrusions 1114 may be formed on outer surface 1116 of oblique dome 1110. Oblique dome 1110 may have a diameter rangine from 0.1 to 1.5 mm. The dimension of the “bumps” may range as well, such as from 0.001 to 0.028, such as small bumps having three dimensional measurements of x0.002, y0.001, z0.002 or large bumps having three dimensional measurements of x0.028, y0.003, z0.028, with the bumps being shaped as round, oval or oblong. When multiple irregularly placed protrusions 1114 are present on oblique dome 1110, it is important that the placement of irregularly placed protrusions 1114 not create a discernable pattern. Such a pattern may be off-putting to infants, whose instincts are keyed to the random shape of their mothers' nipples. Indeed, irregularly placed protrusions 1114 may come in a plethora of shapes and sizes in order to create the irregular random texture of a mother's nipples by employing different sized, different shaped, and different height dimensions of the nipples. Thus, several different kinds of irregularly placed protrusions 1114 can be placed on the same oblique dome 1110 to better mimic human flesh of the areola. The human areola, see FIGS. 8 and 10, show asymmetrical “bump” distribution upon which the current disclosure is modelled. The texture of these tiny, asymmetrical bumps around the base of nipple simulate bumps on the human areola and give lips sensory feedback for placement of tongue and lips to the feeding infant. The current disclosure nipples may also be shorter than competitor nipples to avoid gagging sensitive infants. FIG. 12 shows an alternate, perspective view of mimic nipple 1110. FIG. 13 shows a downward view looking onto mimic nipple 1100 showing that oblique dome 1110 and irregularly placed protrusions 1114 do mimic a human areola and nipple in appearance. FIG. 14 shows pacifier (Calm-Me) 1402 that may incorporate aspects of the current disclosure, including but not limited to oblique dome 1110 and nipple protrusion 1102 flaring to meet and be affixed to a support base 1402, which may include handle 1404. Pacifier 1402 will lack a hole as found in nipples used with bottle or the feeding system described herein. The similarity of shape and texture in its exactness of the nipple prevents a baby from having to transition from one shape and texture to another when feeding and then soothing by sucking on the (Calm-Me) pacifier. The handle allows for the pacifier to be attached to a ribbon-like pacifier holder with a clip to the baby's clothing (these are already on the market). The handle also allows for a more mature baby to hold the pacifier by the handle and place it in or take it out of its own mouth FIG. 15 shows an infant medicine/feeding dispenser (Heal-Pro)1500 that may incorporate oblique dome 1110 and nipple protrusion 1102, as well as support base 1402 and handle 1404, with a leur feeding lock 1502 and feeding tube 1504. Feeding tube 1504 may be from 0.5 to 10 inches long, such as a Qosina model 41521 catheter hub connector or Luer slip lock and or Enfit locks. The tubing may be formed from food grade, radiopaque and or translucent silicone and may be an elastomeric tube. The tubing will connect inside the tip of the nipple and be flush with its surface so that the baby will not be able to sense the end of the tubing. The length of the tubing should not exceed 10 inches so as not to be a choking hazard to the baby. The tubing allows for dispensation of fluid (medicine or milk) in exact dosage/prescribed amounts in a controlled manner relating to flow rate and proportion. It also allows for the baby to receive such fluids in any safe position, minimizing the amount of handling or transition of position to be inflicted upon the baby. For example, a baby could be given medicine while in a side-lying position or on the baby's tummy in a crib or even in an isolette in a hospital setting as well as cradled in a caregiver's arms. The syringe allows for the extreme control of the flow rate down to tenth of a cubic centimeter at a time. This reduces the chance of foreign fluid entering the airway leading to the lungs of the infant, otherwise known as aspiration.

The current disclosure's Dru Feeding System™ nipples are custom designed for baby's individual skill set. It is a common myth that all babies go from a slow flow nipple to faster flows with maturity. The Dru Feeding System's™ incremental increase in flow rate is designed to satisfy every baby where they are in development, no matter the age. A preemie is usually born with a consistently strong reflexive suck and therefore needs a slower flow rate for coordination of sucking, breathing and swallowing. The precision of each nipple delivers a consistent flow rate, allowing the same flow rate every time. Dru Feeding System™ nipples feel and look like Mom's natural breast, with asymmetrical distribution, non-uniform bumps, and a wide base. The pacifier shares the identical shape and texture, as does the original design of the medicine dispenser (Heal-Pro). There is no transition from shapes and textures in any of Dru Feeding System's™ products, which greatly increases a baby's acceptance and success. Whether feeding, soothing with a pacifier, or providing needed medicine, a baby's experience is consistent and comforting, increasing bonding and reducing stress.

Any of the devices herein may be presented as a combination kit. As used herein, the terms “combination kit” or “kit of parts” refers to the components that are used to package, sell, market, deliver, and/or administer the pacifiers and feeding systems described herein. Such additional components include, but are not limited to, packaging, syringes, blister packages, formula, medicaments, bottles, and the like, the combination kit can contain each agent or other component in separate formulations. The separate kit components can be contained in a single package or in separate packages within the kit.

In some embodiments, the combination kit also includes instructions printed on or otherwise contained in a tangible medium of expression. The instructions can provide information regarding the content of the compounds and/or formulations, safety information regarding the content of the compounds and formulations (e.g., pharmaceutical formulations), information regarding the dosages, indications for use, and/or recommended treatment regimen(s) for the compound(s) and/or pharmaceutical formulations contained therein. In some embodiments, the instructions can provide directions and protocols for administering the compounds and/or formulations described herein to a subject in need thereof. In some embodiments, the instructions can provide one or more embodiments of the methods for administration of the P188 and/or pharmaceutical formulation thereof such as any of the methods described in greater detail elsewhere herein.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A baby nipple formed to more perfectly mimic the human female breast comprising:
a nipple protrusion;
an oblique dome;
wherein the nipple protrusion flairs at a joining point with the oblique dome;
at least one irregularly placed protrusion raised from an outer surface of the oblique dome;
wherein the oblique dome flairs outward then converges inward to join a substantially columnar nipple lid engagement ring; and
wherein the nipple lid engagement ring joins a flat retaining ring.

2. The baby nipple of claim 1, wherein the nipple protrusion contains at least one inner support member.

3. The baby nipple of claim 3, wherein the inner support member is a concentric ring formed on an inner surface of the nipple protrusion.

4. The baby nipple of claim 1, wherein a substantially columnar body of the nipple protrusion slopes inward as the columnar body forms a rounded top hemisphere of the nipple.

5. The baby nipple of claim 1, wherein the nipple protrusion lacks a bulbous tip but instead forms the rounded to hemisphere of the nipple.

6. The baby nipple of claim 1, wherein the at least one irregularly placed protrusion is substantially round.

7. The baby nipple of claim 1, wherein multiple irregularly placed protrusions are present on the oblique dome.

8. The baby nipple of claim 7, wherein the multiple irregularly placed protrusions possess varying shapes and sizes.

9. A method for forming a more perfect mimic for the human female breast comprising:
forming a nipple protrusion;
forming an oblique dome;
forming the nipple protrusion to flair at a joining point with the oblique dome;
forming at least one protrusion on an outer surface of the oblique dome;
flaring the oblique dome outward then converging it inward to join a substantially columnar nipple lid engagement ring; and
forming the nipple lid engagement ring to join a flat retaining ring.

10. The method of claim 9 further comprising, forming at least one inner support member inside the nipple protrusion.

11. The method of claim 10 further comprising, wherein the inner support member is a concentric ring formed on an inner surface of the nipple protrusion.

12. The method of claim 9 further comprising, forming a substantially columnar body for the nipple protrusion that slopes inward as the columnar body forms a rounded top hemisphere of the nipple.

13. The method of claim 9 further comprising, wherein the nipple protrusion lacks a bulbous tip but instead forms a rounded to hemisphere of the nipple.

14. The method of claim 9 further comprising, shaping the at least one irregularly placed protrusion to be substantially round.

15. The method of claim 9 further comprising, forming multiple irregularly placed protrusions on the oblique dome.

16. The method of claim 15 further comprising, forming the multiple irregularly placed protrusions to possess varying shapes and sizes.
